(19) United States
(12) Patent Application Publication
(10) Pub. No.: US 2026/0361566 A1
(43) Pub. Date: Nov. 12, 2026

(54) MITIGATION OF MANIPULATIONS IN A COMPUTER SYSTEM WITH ZONE SEPARATION FOR A DEVICE, IN PARTICULAR FOR A VEHICLE

(71) Applicant: Robert Bosch GmbH, Stuttgart (DE)

(72) Inventors: Marcel Kneib, Ingelheim (DE); Lara Hallaczek, Stuttgart (DE); Manuel Jauss, Wissgoldingen (DE)

(21) Appl. No.: 19/100,238

(22) PCT Filed: Jan. 6, 2025
(86) PCT No.: PCT/EP2023/074471

§ 371 Date: Jan. 31, 2025

(30) Foreign Application Priority Data
Sep. 16, 2022 (DE) 10 2022 209 779.3

(51) Int. Cl. H04L 12/40; G06F 9/50

(52) U.S. Cl. CPC H04L 12/40104; G06F 9/5044; H04L 2012/40273

(57) ABSTRACT

A computer-implemented method for mitigating a manipulation in a computer system for a device, in particular for a vehicle. The computer system includes a plurality of zones, a plurality of system resources, and a module for mitigating zone manipulations in each of the plurality of zones. A first zone is assigned a first number of system resources. A second zone is assigned a second number of system resources, which second number differs from the first number of the plurality of system resources. The method includes identifying the possibility of a manipulation of the first zone of the plurality of zones and/or of a manipulation of the second zone of the plurality of zones in the module for mitigating zone manipulations; and initiating, by means of the module for mitigating zone manipulations, a countermeasure to mitigate the manipulation of the first zone and/or the manipulation of the second zone.

### FIELD

The present invention relates to techniques for mitigating a manipulation in a computer system for a device, in particular for a vehicle. Associated aspects of the present invention relate to a module for mitigating zone manipulations, to a computer system for a device, to a device, and to a computer program.

### BACKGROUND INFORMATION

Recently, vehicles are becoming increasingly connected to one another and/or to a backend located in a cloud. More specifically, the vehicles have one or more interfaces via which data are received and/or sent during operation of a vehicle, which data are in turn used to operate the vehicle.

Additionally, the complexity of the components of the vehicles and of their software is increasing continuously, in particular in the context of autonomously or semi-autonomously operating vehicles and the demand for “more intelligent mobility,” which implies integration of the vehicle into the digital world.

Cybersecurity therefore plays an increasingly important role in the software and hardware development for modern vehicles. In addition, problems in some methods of the related art with respect to cybersecurity arise from the variety of applications provided by different manufacturers and executed on different systems in the vehicle.

In this context, some methods of the related art are based on the concept of zone separation, i.e., the concept of separating trusted zones within a control unit (electronic control unit (ECU) ), which isolates more exposed components from less exposed components in order to reduce the attack surface.

However, some methods of the related art are unable to identify violations of different zones with respect to these allocations in their entirety as a result of an intrusion attempt in good time and to respond appropriately thereto.

There is therefore a need to develop new, more efficient techniques that can solve some or all of the aforementioned problems.

### SUMMARY

A first general aspect of the present invention relates to a computer-implemented method for mitigating a manipulation in a computer system for a device, in particular for a vehicle. The computer system of the first aspect includes a plurality of zones, a plurality of system resources, and a module for mitigating zone manipulations that is designed to mitigate zone manipulations in each of the plurality of zones. A zone of the first aspect is a logically and/or physically delimitable unit in the computer system. In addition, a first zone of the plurality of zones is assigned a first number of system resources of the plurality of system resources. Furthermore, a second zone of the plurality of zones is assigned a second number of system resources of the plurality of system resources, which second number differs from the first number of the plurality of system resources. According to an example embodiment of the present invention, the method comprises identifying the possibility of a manipulation of the first zone of the plurality of zones and/or of a manipulation of the second zone of the plurality of zones in the module for mitigating zone manipulations. In this case, a manipulated zone is a zone for which violations of rules relating to the assignment of system resources assigned to this zone have been identified. The method furthermore comprises initiating, by means of the module for mitigating zone manipulations, a countermeasure to mitigate the manipulation of the first zone and/or the manipulation of the second zone.

A second general aspect of the present invention relates to a module for mitigating zone manipulations of a computer system, which is designed to perform the computer-implemented methods according to the first general aspect.

A third general aspect of the present invention relates to a computer system for a device, in particular for a vehicle, which comprises the module for mitigating zone manipulations according to the second general aspect and a plurality of zones.

Furthermore, the computer system of the third aspect comprises a plurality of system resources, which are assigned to corresponding zones of the plurality of zones.

A fourth general aspect of the present invention relates to a device comprising the computer system according to the third general aspect.

A fifth general aspect of the present invention furthermore relates to a computer program containing commands that, when executed by a computer system, cause the computer system to perform the computer-implemented method according to the first general aspect.

The techniques of the first to fifth general aspects of the present invention can have one or more of the following advantages.

On the one hand, with the present techniques, a greater differentiation of the security requirements in a computer system (e.g., vehicle computer) can be realized than in some techniques of the related art, in that the computer system is divided into zones (and, for example, system modules of the computer system are assigned to the corresponding zones). For example, the system modules that are particularly relevant to the operational safety of a device (e.g., a vehicle) (e.g., because they represent safety-critical functions for this device) may be assigned to different zones than the system modules that are less relevant to the operational safety of the device (e.g., because they represent less safety-critical functions for this device). However, in some cases, the zones with system modules that are less relevant to operational safety may be more prone to interventions or manipulation from outside, for example in the context of a cyberattack. In addition, the zone separation in the computer system can reduce the likelihood that a successful manipulation in one zone will spread to other zones.

Secondly, the techniques of the present invention can identify possible interventions in computer systems more efficiently than some techniques of the related art. In particular, violations of rules relating to assignments of system resources to different zones (e.g., unauthorized access to system resources by these zones) can indicate that there is intervention, or that the intervention did not take place if the rules relating to assignments of system resources to the zones have been complied with (e.g., these zones only access the allowed system resources).

Thirdly, the present techniques provide the possibility of responding to zone manipulations (e.g., due to an intervention) in a computer system of a device (e.g., in a vehicle) in a centralized manner in good time by means of a module for mitigating zone manipulations in that it initiates appropriate countermeasures to mitigate zone manipulation (e.g., by changing access rights to system resources assigned to a manipulated zone, assuming a functionality of the manipulated zone by another zone, and/or other appropriate countermeasures, more on this below). The present techniques can thus manage possible interventions in a computer system more quickly and efficiently than some techniques of the related art.

Some terms in the present disclosure are used in the following manner:
A “system module” may comprise a hardware and/or software unit, which provides a plurality of functions for a device (e.g., for a vehicle). A system module may comprise one or more processors, controllers, control units, (communication) interfaces, network components, software applications, software architectures, any other software/and/or hardware components, parts or any combination thereof, or be one or more of the aforementioned realizations of system modules. A system module or its part may be arranged in a zone or in a subzone.
A “zone” may be a logically (functionally) and/or physically (locally) delimitable unit in a system. In other words, two or more zones are logically delimited from one another if they are separated from one another on a software basis (e.g., represent different logical models in one software), while two or more zones form physically delimitable units if they are locally separated from one another (e.g., are located in different computing units or parts thereof). A zone may comprise one or more system modules and/or a part and/or parts of one or more system modules. A zone may be defined, i.e., determined, by its constituents. All system modules or parts of system modules assigned to a zone may form the zone. A zone may comprise various computing units, computing cores, controllers, control units, storage units, peripherals, (communication) interfaces, network components, software applications, software architectures, bus systems (e.g., CAN bus systems in vehicles), any other software/and/or hardware components, parts or any combination thereof. Multiple zones may form an entire system (e.g., an entire computer system). A “zone” in some examples may be divided into two or more “subzones,” which together may form this zone. A “subzone” may be a logically (functionally) and/or physically (locally) delimitable subunit of a zone. Similarly to a zone, a subzone may comprise one or more system modules or parts thereof, which are assigned to the corresponding zone.

The term “system resource” may refer to any resources that, in their entirety, ensure the (at least partial) executability of one or more functions of the computer system for a device (e.g., for a vehicle). A “system resource” may be a software and/or hardware component that provides services for system modules.

For example, a system resource may comprise one or more memories, one or more peripherals (e.g., in-vehicle and/or off-vehicle peripherals), a system resource connected to the energy supply, or any combination thereof. The term “software component” (or “software”) may basically be any part of software of a component (e.g., of a control unit) of the present disclosure. In particular, a software component may be a firmware component of a component of the present disclosure. “Firmware” is software that is embedded in (electronic) components and provides basic functions there. Firmware is functionally fixedly connected to the corresponding hardware of the component (so that one cannot be used without the other). It may be stored in a non-volatile memory, such as a flash memory or an EEPROM. A zone of the present disclosure may be allowed or denied access to a system resource. For example, a zone may be allowed to access a system resource through an access right (more on this below). A “system resource” may be assigned to a zone or subzone, or may be independent of the zone separation in a computer system, i.e., not assigned to a zone or subzone.

The term “system resource” may also refer to a “communication resource” (e.g., may comprise a bus system, in particular a CAN bus system in a vehicle, or parts thereof or may be a bus system or parts thereof), which may comprise, for example, properties of a communication link via a transmission path, or multiple transmission paths in the computer system in the case of multi-path communication (e.g., using multi-path TCP), which can be described as a set of transmission parameters (e.g., by means of a data rate, transmission capacity, transmission latency, transmission bandwidth, transmission reliability, or any combination thereof). The corresponding communication may, for example, take place between in-vehicle and/or off-vehicle modules/components via one or more radio networks, for example 5G, LTE cellular networks or WLAN networks, or via a near-field communication link or Bluetooth. For example, communication resources may comprise communication interfaces (e.g., one or more of I2C, SPI, CAN, LIN, USB, PCIe, Bluetooth, and Wi-Fi).

A “memory” may be a data store or also a data carrier on which the data are stored. A computer and/or any type of peripheral device may read or write to a memory. A memory may be a semiconductor memory and/or a magnetic memory or a memory based on a technology not mentioned here. A memory may be a volatile memory and/or a non-volatile memory. A memory may comprise one of DRAM, RAM, ROM, EPROM, HDD, SDD, etc. on which data are stored.

A “peripheral” may be a component that can be connected to a (central) computing unit. Such a component may require control by the computing unit and, where applicable, initialization. A component may be a “vehicle component.” A peripheral may comprise a part of a computer that provides functionalities that can be provided by additional hardware rather than by a computing core itself. For example, a peripheral may comprise an analog-to-digital converter (ADC), a safety-related peripheral, a security-related peripheral (MPU, MMU, or others), a timer, or an interface, such as an SPI interface (serial peripheral interface), or another interface mentioned above.

The term “vehicle component” refers to any internal components of a vehicle. A vehicle component may be an engine (e.g., an internal combustion engine, an electric engine, a hybrid engine or a fuel cell or parts of an engine, such as a turbocharger), a control device (e.g., an engine control unit), a battery or other energy-absorbing systems, components of a powertrain (e.g., a transmission), assistance systems (e.g., brake assistants, lane keeping assistants, parking assistants), air-conditioning systems, sensor or sensor systems (e.g., camera-based systems, LIDAR systems, RADAR systems, ultrasonic sensor systems), or electronic systems for controlling functions of the interior. A vehicle component may also be a part of the systems described above or a combination of a plurality of the systems described above (or parts thereof).

A “computer system” of the present disclosure may comprise a (e.g., central) vehicle computer (e.g., a vehicle computer may form the computer system). The computer system may comprise systems within a vehicle (e.g., system modules and/or vehicle components in the sense defined above). In some cases, the computer system may also comprise systems external to the vehicle (e.g., off-vehicle peripherals, data cloud systems, other components, or any combination thereof). In this context, a “vehicle computer” is a class of highly integrated electronic vehicle control units that are characterized by a many times higher computing power in comparison to ECUs on a microcontroller basis. VCs are designed with at least one microprocessor and one communication interface. A vehicle computer may also contain one or more physical or virtual switches, system-on-a-chip (SoC) hardware with multiple CPU cores, co-processors and powerful graphics cards, on which, for example by means of a hypervisor, multiple virtual machines execute various operating systems connected via a virtual switch (e.g., implemented in the hypervisor). Alternatively or additionally, VCs may use container technologies based on generating a container in order to provide virtual resources. VCs generally run complex software for a variety of tasks with a variety of requirements, in particular for time-critical and safety-critical functions. VCs communicate with other systems in the vehicle, in particular with vehicle components, user interfaces, and with other VCs or ECUs (any combination of these alternatives is also possible). VCs may also communicate with off-vehicle systems, such as cloud systems, smartphones, charging infrastructure, traffic control technology, or other vehicles. In addition, the computer system may contain a bus system, which may be used to realize multiple logical/physical communication links between different constituents of the computer system (e.g., by means of corresponding physical communication channels). One possible example of such a bus system in the vehicle sector is the controller area network bus system (CAN bus system).

In other cases, “a computer system” may comprise an embedded system (e.g., an embedded system may form the computer system). An embedded system is an electronic computer that is incorporated into a technical context. An embedded system may perform regulating, controlling, monitoring functions, or data processing tasks. In still other examples (or additionally), the computer system may comprise one or more control units (ECUs) (e.g., one or more control units may form the computer system).

A “function” may be any task (or subtask) performed in the operation of a device. A function may relate to controlling, regulating, or monitoring the device or a part of the device (e.g., a component of the device). Additionally or alternatively, a function may relate to data processing or signal processing in the device (e.g., a communication function). The term “function” in the vehicle sector comprises control-based functions of a vehicle, for example functions of driving assistance systems or parking assistance systems, functions for autonomous or semi-autonomous driving, functions of an entertainment system and functions for the reception, transmission and storage of various data between different systems (e.g., system modules and/or vehicle components) of the computer system (or any combination of the aforementioned functions). Within the scope of the present disclosure, functions in conjunction with air-conditioning systems and/or electronic systems for controlling functions of the interior are also possible. The executability of the function may be the responsibility of a corresponding “system module,” which may communicate, for example, with corresponding other systems, e.g., components (e.g., vehicle components), other system modules within the vehicle, or off-vehicle functional units (as mentioned above), or a combination thereof.

A “software architecture” may be a structured and/or hierarchical arrangement of the system components, as well as a description of their relationships in a software system, wherein system components may be software parts the relationships of which to one another and the properties of which may be described by the software architecture. For example, the software architecture of AUTOSAR (automotive open system architecture) is an open and standardized software architecture for electronic control units (ECUs) in the automotive sector. For example, the AUTOSAR Classic Platform and the AUTOSAR Adaptive Platform are two different software architectures.

A “module for mitigating zone manipulations” (e.g., a central “module for mitigating zone manipulations”) may be a component that identifies a possible zone manipulation and initiates a countermeasure to mitigate the (identified) zone manipulation (more on this below). The module for mitigating zone manipulations may be a hardware unit, which may have its own memory, preconfigured hardware logic, one or more registers, and an internal data link. (A register may, for example, contain or describe memory areas.) The module for mitigating zone manipulations may also comprise respective logical and/or physical connections to the zones (including, for example, system modules). In this context, a module for mitigating zone manipulations may have one or more interfaces to the outside, e.g., to the zones, to a computing core, to one or more communication links, or any combination thereof. The module for mitigating zone manipulations may be part of a processor (central processing unit, CPU). In some cases, the module for mitigating zone manipulations may be integrated into a vehicle computer or may be designed as a standalone component (e.g., in-vehicle or off-vehicle component) that communicates, for example, with the vehicle computer (in the latter case, the computer system of the present disclosure may comprise the vehicle computer and the module for mitigating zone manipulations). The module for mitigating zone manipulations may communicate to the outside via corresponding communication protocols (e.g., with system modules, components, other constituents of a computer system, or any combination thereof).

A “security module” (e.g., a central security module) may be a component for identifying violations of rules relating to the assignment (or, in other words, relating to the allocation) of (allocated) system resources to the respective zones (including, for example, system modules). Furthermore, the security module of the present disclosure may serve the purpose of centralized collection and processing of determined violations. The security module may be part of the computer system or may be located outside the computer system and may communicate with the computer system, for example. The security module may be a hardware unit, which may have its own memory, preconfigured hardware logic, one or more registers, and an internal data link. (A register may, for example, contain or describe memory areas.) A security module may also comprise respective logical and/or physical connections to the zones (including, for example, system modules). In this context, a security module may have one or more interfaces to the outside, e.g., to the zones, to a computing core, to one or more communication links, or any combination thereof. The security module may be part of a processor (central processing unit, CPU). In some cases, the security module may be integrated into a vehicle computer or may be designed as a standalone component (e.g., an in-vehicle or off-vehicle component) that communicates with the vehicle computer, for example.

A “domain controller” may comprise a peripheral implemented in hardware and may manage access rights to memories and/or external peripherals, for example. A domain controller may segregate various peripherals and/or protect the memory of a system, wherein a domain of a domain controller may be a contiguous area that has the same access rights to peripherals and/or memories. For example, a domain controller may be an extended resource domain controller (XRDC), which is a peripheral of the S32G274A processor that is implemented in hardware. The latter is a high-performing vehicle network processor of the S32G2 family of the semiconductor manufacturer NXP and represents a system-on-chip (SoC) comprising a microcontroller (μC) and microprocessor portions (μP portions).

A “computing core” refers to the central part of a microprocessor, wherein multiple computing cores may also be present in a microprocessor. A computing core may carry out arithmetic and/or logical operations on entered data and/or information.

A “vehicle” may be any device that transports passengers and/or freight. A vehicle may be a motor vehicle (for example, a car or a truck) but also a rail vehicle. A vehicle may also be a motorized, non-motorized, and/or muscle-powered bicycle or tricycle. However, floating and flying devices may also be vehicles. Vehicles may be autonomously operating or at least semi-autonomously operating or assisted. For example, in the present disclosure, the vehicle may comprise a partially or fully autonomous robot (e.g., an industrial robot).

The term “identifying a possibility . . . ” means that certain events (e.g., signals or their absence) are interpreted according to predetermined rules in order to identify a state in which manipulation of one or more zones may be present.

### BRIEF DESCRIPTION OF THE DRAWINGS

FIG. 1A is a flowchart showing an exemplary embodiment for a computer-implemented method of the present invention for mitigating a manipulation in a computer system for a device, in particular for a vehicle.

FIG. 1B is a flowchart showing further possible method steps according to the first aspect of the present invention.

FIG. 2 schematically shows an exemplary embodiment of a computer system 100 for a device. The computer system of FIGS. 1A and 1B comprises four zones 20-23 (dashed boxes), six system modules 30-35, and a module for mitigating zone manipulations 10. Also shown in this figure are two computing units 40, 41 and five interfaces 50-54.

FIG. 3 illustrates an exemplary embodiment of the computer system (without the third zone 22 for the sake of simplicity), which has peripherals 60, 61, two memories 62, 63, and a domain controller 70 in addition to the exemplary embodiment of FIG. 2.

### DETAILED DESCRIPTION OF EXAMPLE EMBODIMENTS

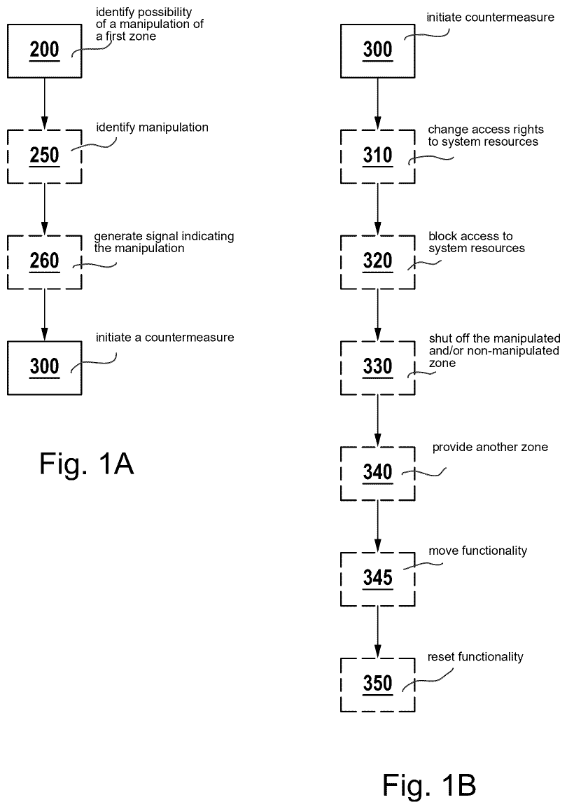

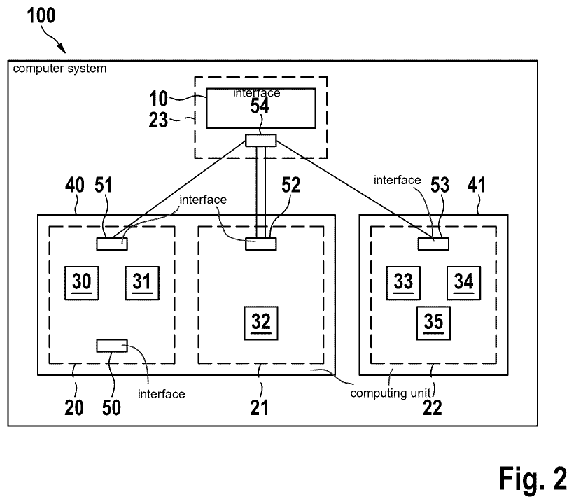

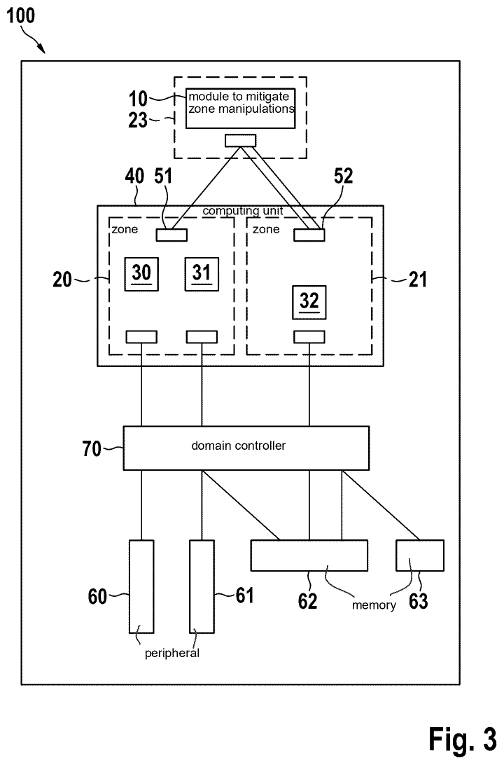

First, techniques for mitigating a manipulation in a computer system for a device, in particular for a vehicle, are described with reference to FIGS. 1A and 1B. Two exemplary structures of a computer system are then discussed with reference to FIGS. 2 and 3.

As outlined in FIGS. 1A and 1B, a first general aspect relates to a computer-implemented method for mitigating a manipulation in a computer system for a device, in particular for a vehicle (e.g., an autonomously or semi-autonomously operating vehicle). The method steps of an example embodiment of the present invention are shown in the boxes drawn by solid lines in FIGS. 1A and 1B, while the method steps of some example embodiments of the present invention are shown in the boxes shown by dashed lines.

In the present techniques, the computer system comprises a plurality of zones 20-23, a plurality of system resources 60-63 (e.g., memories, in-vehicle and/or off-vehicle peripherals, communication resources, such as an entire bus system or a part thereof, see above discussions), and a module for mitigating zone manipulations 10 that is designed to mitigate zone manipulations in each of the plurality of zones 20-23 (possible exemplary embodiments of such a computer system 100 are shown in FIGS. 2 and 3). A zone is a logically and/or physically delimitable unit in the computer system (as defined above). For example, one or more, two or more, three or more, four or more, five or more, six or more, ten or more, twenty or more, fifty or more, one hundred or more zones may be separated in the computer system 100. In a non-restrictive example of FIG. 2, four zones 20, 21, 22, and 23 are shown.

The computer system 100 of the first aspect may be designed to provide a plurality of functions for the device, in particular for the vehicle. In addition, the computer system 100 may furthermore comprise a plurality of system modules 30-35 (e.g., hardware and/or software units as mentioned above), wherein the plurality of system modules is configured to provide functions for the device (e.g., functions for controlling, regulating, or monitoring the device, as discussed above). In the present techniques, each system module or a part of a system module of a first number of system modules 30, 31 of the plurality of system modules may be assigned to the first zone 20 of the plurality of zones 20-23. In addition, each system module or a part of a system module of a second number 32 of system modules of the plurality of system modules may be assigned to the second zone 21 of the plurality of zones. In FIG. 2, six system modules 30 to 35 are shown by way of example. The two system modules 30, 31 (the first number of system modules in this example) are assigned to the first zone 20, while the one system module 32 (the second number of system modules in this example) is assigned to the second zone 21 (this arrangement is also shown in the exemplary embodiment of FIG. 2). In the same way as for the two zones 20 and 21, one or more other system modules or parts thereof which are not assigned to either of the two zones may be assigned to corresponding other zones that differ from the first and second zones. In the example of FIG. 2, three system modules 33, 34, and 35 are assigned to the third zone 22.

In some cases, one or more, two or more, three or more, four or more, five or more, six or more, ten or more, twenty or more, fifty or more, one hundred or more system modules (e.g., processors or other realizations of system modules according to the above definitions) or parts thereof (e.g., computing cores) may be arranged in a zone. For example, the first zone 20 may comprise a portion (e.g., two computing cores) of the plurality of computing cores of a processor (e.g., four computing cores) and the second zone 21 may comprise a different portion (e.g., two remaining computing cores) of the plurality of computing cores of the processor (not shown in the figures). For example, a first software application may be executed on a computing core of the processor assigned to the first zone 20, and a second software application may be executed on at least one computing core assigned to the second zone 21. In some examples, a zone may comprise interfaces, bus systems, or parts thereof. By way of example, FIG. 2 shows the first zone 20, which comprises a first interface 50 and a second interface 51, a second zone 21, which comprises an interface 52, and the third zone 22, which comprises an interface 53. For example, an interface may comprise a CAN bus interface, a CAN FD bus interface, and/or a GMAC port.

In the techniques of the present invention, a first zone 20 of the plurality of zones is assigned a first number of system resources 60-62 (e.g., software and/or hardware components) of the plurality of system resources 60-63. In addition, a second zone 21 of the plurality of zones is assigned a second number of system resources 62, 63 of the plurality of system resources 60-63, which second number differs from the first number of the plurality of system resources. As discussed above, system resources may provide corresponding services for system modules and are required, for example, for the executability of one or more functions of the computer system. The second number of system resources 62, 63 may be more limited than the first number of system resources 60-62. For example, the second number of system resources may comprise fewer system resources than the first number of system resources. Alternatively or additionally, the second zone 21 may have fewer access rights to the same or other system resources, as explained in more detail below. In a non-restrictive example of FIG. 2, two peripherals 60, 61 and one memory 62 (the first number of system resources in this example) are assigned to the first zone 20 (e.g., by means of a domain controller 70, more on this below), while two memories 62, 63 (the second number of system resources in this example) are assigned to the second zone 21. In the example of FIG. 2, the same system resource, namely, the memory 62, is assigned to the two zones 20, 21, and the other system resources 60, 61, and 63 are assigned to the first 20 and the second zone 21, respectively. In some cases, the same system resource may be assigned to two or more zones. In other cases, a system resource may be assigned only to a corresponding zone and not to any other zone.

The first step of the method comprises identifying 200 the possibility of a manipulation of the first zone 20 of the plurality of zones 20-23 in the module for mitigating zone manipulations 10. Alternatively or additionally, the method of the first aspect comprises identifying 200 the possibility of a manipulation of the second zone 21 of the plurality of zones 20-23 in the module for mitigating zone manipulations 10. In this case, a manipulated zone is a zone for which violations of rules relating to the assignment (or, in other words, relating to the allocation) of system resources assigned to this zone have been identified. As explained below, the first and/or the second zone (e.g., system modules assigned to these zones) may, for example, access a prohibited system resource due to an external intervention (or, in other words, intrusion from outside) (e.g., the first zone 20 may access the memory 62 by writing even though this zone is only allowed to access the memory by reading, more on this below).

In the techniques of the present disclosure, a manipulation of the first zone 20 may be identified 250 (or, in other words, detected), for example by a security module (see definitions above) and/or by another corresponding module (e.g., a system module) assigned to the manipulated zone (not shown in the figures). Alternatively or additionally, a manipulation of the second zone 21 may be identified 250. In addition, a signal indicating the manipulation of the first zone 20 and/or of the second zone 21 may be generated 260. The signal may be generated in the security module (e.g., in a central security module) and/or in the other corresponding module (e.g., for the module for mitigating zone manipulations 10). In this case, identifying 200 the possibility of the manipulation of the first zone 20 and/or of the second zone 21 may be carried out based on the signal indicating the manipulation of the manipulated zone. In particular, the security module and/or the other corresponding module may be configured to send the generated signal. The module for mitigating zone manipulations 10 may in turn be configured to receive the generated signal. In addition, this signal may, for example, be processed (e.g., interpreted on the basis of predetermined rules) in the module for mitigating zone manipulations in order to determine whether a manipulation has occurred in the respective zone or not.

Additionally or alternatively, identifying may comprise identifying an absence of an (expected) signal. In some cases, the aforementioned security module and/or the other corresponding module may be configured to send the signal to the module for mitigating zone manipulations 10 on a predetermined schedule (e.g., regularly once per a predetermined time interval and/or irregularly if the respective consecutive time intervals between the signals sent vary). In this case, the absence of the signal at a pre-planned (expected) point in time on the part of the module for mitigating zone manipulations 10 can be interpreted as a corresponding manipulation.

In the present techniques, identifying the possibility of a manipulation of the other zones (e.g., the third, fourth, fifth zone, etc.) can be carried out in the same way as for the first or second zone.

In the next step, the present techniques comprise initiating 300, by means of the module for mitigating zone manipulations 10, a countermeasure to mitigate the manipulation of the first zone 20. Alternatively or additionally, the module for mitigating zone manipulations 10 initiates a countermeasure to mitigate the manipulation of the second zone 21. The method step “initiating” can be carried out in response to identifying the possibility of a manipulation of the first zone 20 and/or of a manipulation of the second zone 21. In other words, the module for mitigating zone manipulations 10 can initiate the countermeasure to mitigate effects of manipulations by an external intervention (e.g., a cyberattack) on the computer system. In some cases, such a countermeasure can result in a change to access rights to system resources allocated to a manipulated zone, as explained in detail below. For example, if a zone has two or more different access rights to use a system resource (e.g., in the example of FIG. 2, the zone 20 may use the memory 62 by reading, writing, and executing), a number of access rights to use this system resource may be reduced as a countermeasure (e.g., as a countermeasure, the zone 20 is allowed to use the memory 62 only by reading), more on this below. In this case, the module for mitigating zone manipulations 10 may be granted access rights to system resources allocated to the manipulated zone.

In the computer system 100 of the present techniques, the first zone 20 of the plurality of zones may be more trustworthy than the second 21, less trustworthy zone of the plurality of zones, wherein the risk of a manipulation of a more trustworthy zone is lower than that of a less trustworthy zone. As mentioned above, a manipulation may comprise an external intervention that reduces the operational safety of the device. Furthermore, in some cases, a third zone 22 of the plurality of zones may be more trustworthy than or as trustworthy as the first zone 20. In other cases, the third zone 22 may be more trustworthy than or as trustworthy as the second zone 21 and less trustworthy than the first zone. In still further cases, the third zone 22 may be less trustworthy than the second zone 21 and the first zone 20. In this way, other zones (e.g., all zones) of the plurality of zones can also be classified as to how trustworthy they are in relation to one another.

To what extent a zone of the plurality of zones is more trustworthy or less trustworthy, i.e., the degree of trustworthiness, may be based on a classification of zones 20-23 on the basis of a security level. The computer system of the present disclosure may have at least two security levels but may also have more than two security levels (e.g., more than five). The degree of trustworthiness, or the security level, may be determined by the configuration of the corresponding zone (e.g., the system modules contained therein). For example, the degree of protection, or the extent of protection measures by which the system modules of a zone 20-23 are, for example, protected against manipulation, for example in the context of an external intervention, may determine whether a zone 20-23 is more trustworthy or less trustworthy or which security level it has (e.g., the presence of certain hardware-based and/or software-based protection measures in the system modules of the zone). Furthermore, the amount of communication of the system modules arranged in the corresponding zone, with external systems, such as a backend, may determine what degree of trustworthiness a zone has or which security level it has. For example, a zone that communicates predominantly or solely within the computer system may be more trustworthy than a zone that communicates at least to some extent with external systems (e.g., a backend, other devices such as vehicles, or infrastructure components).

In some examples, the zones may be classified with respect to their trustworthiness into non-trustworthy zones and trustworthy zones. For example, two zones 20, 21 as described here may be trustworthy, and a less trustworthy third zone 22 may, for example be non-trustworthy (see FIG. 2). For example, the computer system 100, or a computer system of a vehicle, may be the target of a cyberattack, whereby safety-critical functions, for example a braking function in a vehicle, can be disabled or manipulated such that a hazardous situation may arise. A more trustworthy zone 20, 21 is a zone whose manipulation is less likely than that of a less trustworthy zone 22. For example, a zone 22 comprising multimedia functions and having many interfaces for communicating with a backend may be a less trustworthy zone 22 since the likelihood of an external intervention in a communication channel to the backend is higher than in the case of a zone 20 that predominantly comprises functions that require only information from within the vehicle and/or perform processes only within the vehicle. In addition, the module for mitigating zone manipulations 10, which is responsible for initiating countermeasures to mitigate the manipulation in various zones, may be assigned to the first zone 20 of the plurality of zones or to another zone 23 of the plurality of zones that is more trustworthy than the first zone. In some cases, the module for mitigating zone manipulations 10 may be assigned to the most trustworthy zone 23 of the plurality of zones (e.g., the module for mitigating zone manipulations 10 may be assigned to the fourth, most trustworthy zone 23, as illustrated by FIGS. 2 and 3).

In the present techniques, the functions, provided by the system modules, for the operational safety of the device can be of different criticality. A first, more critical function of the plurality of functions may be provided by a system module 30, 31 of the first zone 20, and a second, less critical function of the plurality of functions may be provided by a system module 32 of the second zone 21. In some cases, two or more system modules (e.g., all system modules) of the second zone may provide corresponding functions that are less critical than all functions provided by the system modules of the first zone. In addition to classifying the zones 20-23 according to a degree of trustworthiness, i.e., a security level, the zones are thus also classified with respect to the relevance for operational safety (e.g., by means of a safety level), i.e., the criticality of the function of the zone for the operational safety of the device. A zone 20 whose manipulation can result in a serious hazardous situation is more critical than a zone 21 whose manipulation cannot result in any serious hazardous situation or can result in a less serious hazardous situation. For example, a zone 21 that comprises multimedia functions may be less critical than a zone 20 that comprises a braking function, for example. In the example above, the likelihood that failure of the music in the interior of a vehicle creates a hazardous situation is less than the likelihood that non-functioning of the brakes of a vehicle may cause a hazardous situation. In addition, a zone 23 to which the module for mitigating zone manipulations 10 is allocated may be more critical than one or more (e.g., all) other zones of the plurality of zones. Returning to the example of FIG. 2: The fourth zone 23 is more critical than the other three zones 20, 21, and 22. Classification of the zones on the basis of a safety level or the relevance to the operational safety of the device can be carried out in any appropriate manner. In some examples, the classification may be carried out through the automotive safety integrity level (ASIL) classification, wherein the classification may comprise five levels (QM (least critical), ASIL-A, ASIL-B, ASIL-C, and ASIL-D (most critical)). For example, the relevance, i.e., the criticality, of a zone for operational safety may be derived from the severity, frequency, controllability of a safety hazard, or any combination thereof in the respective zone.

In the present techniques, corresponding access rights to system resources can be assigned to the zones of the plurality of zones. In other words, a zone can be denied access to a system resource or can be allowed such access through an access right. The access rights may comprise allowed access by a zone to a corresponding system resource by reading, by writing, by executing, or any combination thereof. In some cases, one or more access rights assigned to a zone may remain unchanged over time (e.g., the access right may be predefined before or during operation of the computer system). In other cases, one or more access rights assigned to a zone may change over time (e.g., when the computer system is started, a zone is allowed to use a system resource by reading, while this zone is allowed at another point in time to use the same system resource by reading and writing). In an example, access by a zone to a system resource may be classified as allowed if a predetermined criterion is satisfied. In addition, access by the same zone to the system resource may be classified as not allowed if the predetermined criterion is not satisfied. The predetermined criterion may be a criterion relating to context information of the device and/or of a plurality of devices, e.g., context information of a vehicle (or its components) and/or of a vehicle fleet. For example, the context information of the vehicle (or its vehicle components) may comprise information relating to an operating state of the vehicle (or its vehicle components) and/or to predetermined rules for operating the vehicle (or its vehicle components). (This definition may similarly be extended to the entire vehicle fleet.) In another example, the predetermined criterion may require that an expected number of messages sent from a zone in a predetermined period of time (e.g., via a CAN bus system) must be less than or equal to a predetermined value (or must be greater than or equal to a predetermined value). In further examples, the specified criterion may comprise a specified order in which the data are sent from the zone, and/or a specified range contained in the sent data of a particular type (e.g., a value is between a predetermined value and another predetermined value and/or a predetermined pattern is contained therein). In still other examples, the predetermined criterion may comprise one or more criteria mentioned above.

In some cases, the second zone may be assigned fewer access rights to the second number of system resources than the first zone is assigned to the first number of system resources.

Returning to the example of FIG. 2: The first zone 20 of the plurality of zones, which may be more trustworthy than the second, less trustworthy zone 21, may be granted an access right to use the memory 62 to read and write or to read, write, and execute a software application. On the other hand, the second, less trustworthy zone 21 may be granted an access right to use the memory 62 to read, while the access to write and/or execute a software application is denied.

In the present techniques, a violation of rules relating to an assigned system resource for a zone may correspond to unauthorized access by this zone to a system resource for which the corresponding zone is not assigned any access right. For example, the violations of the rules relating to the assignment of the first number of system resources of the plurality of system resources to the first zone may correspond to one or more unauthorized accesses by the first zone to one or more system resources to which the first zone is not assigned any access rights. Alternatively or additionally, the violations of rules relating to the assignment of the second number of system resources of the plurality of system resources to the second zone may correspond to one or more unauthorized accesses by the second zone to one or more system resources to which the second zone is not assigned any access rights. For example, a violation of rules relating to the system resources assigned to the first zone (or another zone) may occur when the first zone (e.g., a system module allocated to this zone) attempts to access a system resource (e.g., a memory) by writing even though it is only allowed to access the system resource by reading. In another example, a violation of rules relating to the system resources assigned to the first zone (or another zone) may occur when the first zone (e.g., a system module allocated to this zone) attempts to execute a system resource (e.g., a software application) even though it does not have any access right to execute this system resource.

In the techniques of the present disclosure, initiating 300 the countermeasure to mitigate the manipulation may comprise changing 310 access rights to system resources assigned to the manipulated zone. In some cases, as mentioned above, the initiated countermeasure may comprise reducing (or, in other words, limiting) a number of access rights to system resources assigned to the manipulated zone. For example, if a zone (e.g., the zone 20 of FIG. 2) is the manipulated zone and had read, write, and execute access rights to a system resource (e.g., to the memory 62) prior to the manipulation, the access rights may be reduced to a read-only access right after the possibility of a manipulation of this zone has been identified.

Alternatively or additionally, initiating 300 the countermeasure to mitigate the manipulation may comprise changing 310 access rights to system resources assigned to the non-manipulated zone. In this case, initiating a countermeasure can be carried out in the non-manipulated zone as a result of identifying a possibility of a manipulation in another zone (i.e., manipulated zone). For example, if a first zone 20 of FIG. 2 is the manipulated zone, and the second (non-manipulated) zone 21 has two or more different access rights to use a system resource (e.g., the zone 21 is allowed to use the memory 63 by reading, by writing, and by executing), a number of access rights of the second non-manipulated zone 21 to use this system resource may be reduced as a countermeasure (e.g., as a countermeasure, the zone 21 is allowed to use the memory 63 only by reading). In some cases, changing 310 access rights to system resources assigned to a manipulated and/or one or more (e.g., all) non-manipulated zones may comprise selecting a predefined configuration with respect to access rights for these zones (as a result of identifying a possibility of a manipulation in a manipulated zone). For example, the predefined configuration may comprise a predefined number of access rights to system resources assigned to the manipulated zone and/or the one or more zones. In the non-restrictive examples, the number of access rights to system resources may include one access right (e.g., read-only access right or execute-only access right) or two access rights (e.g., read access right and execute access right).

In other cases, the countermeasure may comprise blocking 320 access to system resources assigned to the manipulated zone. For example, as a countermeasure, the zone 20 may be denied access to the memory 62 of FIG. 3 due to the identification of a possibility of a manipulation of this zone (because the zone 20 is the manipulated zone). Alternatively or additionally, the countermeasure may comprise blocking 320 access to system resources assigned to the non-manipulated zone (e.g., as a countermeasure, the non-manipulated zone 21 may be denied access to the memory 63 of FIG. 3 due to the identification of a possibility of a manipulation of the zone 20). In still other alternative cases, the countermeasure may comprise shutting off 330 the manipulated and/or non-manipulated zone.

As an alternative or in addition to the method steps “changing 310/blocking 320/shutting off 330,” initiating 300 the countermeasure may comprise providing 340 another zone and moving 345 a functionality of the manipulated zone (in full or at least in part) to the other (provided) zone. In some cases, the step “providing 340” may comprise starting a new zone (e. g., a new zone with one or more system modules contained in this zone). Alternatively or additionally, the step “providing 340” may comprise using a non-manipulated zone that is in operation. (System modules assigned to the non-manipulated zone that is in operation may also be in operation.) In addition, a functionality of one or more system modules assigned to the manipulated zone may be moved to one or more corresponding system modules assigned to the new zone. Alternatively or additionally, a functionality of one or more system modules assigned to the manipulated zone may be moved to one or more corresponding system modules assigned to the non-manipulated zone (that is in operation). In other words, the system modules of the new zone and of the above-introduced non-manipulated zone may be considered to be replacement system modules for the system modules of the manipulated zone that assume the functionalities thereof (e.g., until the functionality of the manipulated zone is restored). For example, the system module 32 of the non-manipulated zone 21 of FIG. 2 that is in operation may assume the functionality of the system module 31 of the manipulated zone 20.

In some cases, providing 340 the other zone and moving 345 the functionality of the manipulated zone to the other zone may comprise assigning system resources of the manipulated zone (e.g., some or all system resources of the manipulated zone) to the new zone and/or the non-manipulated zone. (This may be the case if a possibility of a manipulation of a zone is identified, which is then classified as a manipulated zone.) In addition, corresponding access rights to (assigned) system resources may be assigned to the new zone and/or the non-manipulated zone (e.g., the same access rights as for the manipulated zone prior to its manipulation may be assigned). Returning to the example of FIG. 3: Two peripherals 60, 61 and/or one memory 62 (the first number of system resources in this example) assigned to the zone 20 may be assigned to the non-manipulated zone 21 after the possibility of a manipulation in the zone 20 has been identified. Alternatively or additionally, system resources may be provisioned for the new zone and/or the non-manipulated zone that replaces the manipulated zone. For example, the computer system 100 may contain a number of reserve system resources that is not assigned to any of the zones at the beginning of the operation of the computer system and that is not used until a manipulation is identified in a zone, as described above.

As an alternative or in addition to the above method steps “assigning/provisioning system resources, ” providing 340 the other zone and moving 345 the functionality of the manipulated zone to the other zone may comprise reducing a number of system resources of a zone that is less important than the manipulated zone, and assigning, to the new zone and/or the non-manipulated zone, released system resources that are released by reducing a number of system resources for the less important zone. The two or one of the alternative method steps “assigning system resources to the manipulated zone” and “reducing a number of system resources” may be useful, for example, if the computer system has relatively manageable system resources, so that provisioning of system resources in the computer system is impossible or undesirable due to possible side effects (e.g., communication slowdown in the computer system).

As an alternative or in addition to the method steps “changing 310/blocking 320/shutting off 330/providing 340, ” initiating 300 the countermeasure in the present techniques may comprise resetting 350 a functionality of the manipulated zone using the information relevant to resetting the manipulated zone (or, in other words, reliable, i.e., non-manipulated, information). The relevant information in the computer system may, for example, be stored in a corresponding memory of the computer system, for example in a persistent memory. In the present techniques, the information relevant to resetting 350 the manipulated zone may comprise information relating to firmware of the manipulated zone and/or to firmware of one or more system modules of the manipulated zone. Alternatively or additionally, the relevant information may comprise information relating to settings of the manipulated zone and/or to settings of one or more system modules of the manipulated zone (e.g., communication protocol settings). As an alternative or in addition to the two alternatives mentioned, the relevant information may comprise information relating to the original assignment rules of system resources to the manipulated zone (or, in other words, reliable assignment rules of system resources allocated to the manipulated zone prior to the manipulation). In this case, the original assignment rules may include original access rights of the manipulated zone to system resources allocated to the manipulated zone prior to the manipulation. In some cases, alternatively or in addition to the aforementioned three types of relevant information, the relevant information may contain information relating to further parameters that characterize the manipulated zone.

In some cases, the method step “resetting 350 the manipulated zone” may comprise requesting information relevant to resetting the manipulated zone. For example, the relevant information may be requested by the module for mitigating zone manipulations 10. In an example, the information relevant to resetting the manipulated zone may be generated (e.g., by a corresponding module of the computer system 100, in the form of digital or analog signals, messages, or the like). Alternatively, the information relevant to resetting the manipulated zone may be retrieved (e.g., from a memory of the computer system in which it is stored).

In the techniques of the present disclosure, resetting 350 the manipulated zone may comprise receiving information relevant to resetting the manipulated zone. In this context, the relevant information may be received by the module for mitigating zone manipulations 10 (e.g., in the form of digital or analog signals, messages, or the like). Furthermore, resetting 350 the manipulated zone may comprise recovering a functionality for the manipulated zone on the basis of the relevant information. In this case, restoring the functionality for the manipulated zone may comprise restoring the original assignment rules of system resources (e.g., the original access rights of the manipulated zone to system resources) allocated to the manipulated zone prior to the manipulation. In the present techniques, the step “recovering” may be carried out only using the module for mitigating zone manipulations 10 and/or one or more other modules of the computer system. After the manipulated zone has been reset, it may be used again on the computer system (e.g., to the same or partial extent as prior to the manipulation).

In some examples, resetting 350 the manipulated zone may be resetting the manipulated zone immediately using the relevant information described above (e.g., the manipulated zone may be reset within one minute or within ten seconds). In other examples, resetting 350 the manipulated zone may mean resetting the manipulated zone at a later time (e.g., such a reset may only be started after a predefined time interval has elapsed and/or after processes that have a higher priority than a predefined priority have been carried out in the computer system). In some cases, the immediate reset of the manipulated zone may be ruled out in certain contexts (e.g., by safety criteria). For example, the later reset with respect to such contexts may be carried out in a time period until the next startup process.

In addition, the present techniques may comprise shutting off the started new zone and/or decoupling the non-manipulated zone after resetting the manipulated zone. (In accordance with the above definitions, the new zone and/or the non-manipulated zone is a zone to which the functionality of the manipulated zone can be moved.) In some examples, decoupling the non-manipulated zone may comprise deactivating the non-manipulated zone or returning this zone to its original functionality (e.g., along with system modules assigned to this zone). (As discussed above, the original functionality refers to a functionality prior to identifying a possibility of a manipulation).

Furthermore, initiating 200 the countermeasure to mitigate the manipulation may comprise sending the generated signal indicating the manipulation of the first zone 20 and/or of the second zone 21 (see discussions above), to an external system (e.g., a backend, other devices such as vehicles, or infrastructure components). Alternatively or additionally, the method step “initiating 200” may comprise generating a signal containing context information (discussed above) relating to the device and/or to a plurality of devices, and sending this signal to the external system. For example, external systems can thereby be notified of manipulations (in good time) so that appropriate protection measures can be initiated on the part of the external system. For example, interfaces of an external system (e.g., one or more components such as a gateway, switch, or the like that the external system contains) may be deactivated and/or allowed communication links from the computer system to the external system may be limited (e.g., the communication protocols used to transmit a signal are adjusted accordingly).

In the present disclosure, one or more more trustworthy zones 20, 21 may be formed on a first computing unit 40 of the computer system, and one or more less trustworthy zones 22 may be formed on a second computing unit 41 of the computer system. FIG. 2 shows an example of such a computer system 100 (e.g., the computer system 100 may comprise a vehicle computer, a one-chip system, or an embedded system, see also definitions above), which comprises a first computing unit 40 and a second computing unit 41. For example, a first trustworthy zone 20 and a second trustworthy zone 21 may be formed on the same computing unit 40, and a third non-trustworthy zone 22 may be formed on the second computing unit 41. For example, the zones 20 and 21 may be logically separated from each other on a software basis. In some examples, by being formed on a second computing unit 22, the third zone 22 may be physically, i.e., locally, separated from the first zone 20 and/or the second zone 21.

In some examples, as shown in FIG. 3, the computer system may have a domain controller 70 that contains a plurality of domains (the latter are not shown in this figure). A domain controller 70 may contain one or more, two or more, three or more, four or more, five or more, six or more, seven or more, eight or more domains. In the first aspect of the present techniques, at least the first zone 20 may be allocated to a first domain of the plurality of domains, and the first domain may have the same access rights to system resources as the first zone. In addition, at least the second zone may be allocated to a second domain of the plurality of domains, and the second domain may have the same access rights to system resources as the second zone, wherein fewer access rights to system resources are assigned to the second domain than to the first domain (as described above in connection with the first and second zones). In other words, in some examples, system modules and/or parts of system modules with the same access rights may be allocated to a domain, or the system modules and/or parts of system modules that require the same access rights to system resources to provide the corresponding functions may be allocated to a domain. In some examples, the domain controller may be configured to allow or prohibit access to system resources by system modules 70. In some examples, the access rights to system resources may be assigned (e.g., by means of the domain controller 70) on the basis of the principle of least privilege (POLP). That is to say, the zones only have access rights to the system resources they need to perform their tasks. In other words, the system modules assigned to the zones each have access rights only to the system resources they need to provide the respective functions. In some examples, a domain may be assigned a trustworthiness (security level). For example, a first domain (e.g., domain 0) of the plurality of domains (for example five domains) may be assigned a lower trustworthiness than a fifth domain (e.g., domain 5).

By means of the domain controller 70, in some examples, zones 20, 21 may be assigned access rights to peripherals 60, 61, and/or memories 62, 63. For example, a domain may comprise a logical/physical area that has the same access rights to memories 62, 63 and/or peripherals 60, 61. In addition, in one zone of the plurality of zones (e.g., in the first 20 or in another zone), a system module and/or a part of a system module may comprise a first software architecture and, in another zone of the plurality of zones (e.g., in the second 21 or in another zone), another system module and/or a part of a system module may comprise a second software architecture. For example, in the first zone 20, a system module 30, 31, and/or a part of a system module may comprise an AUTOSAR Classic software architecture and, in the other zone 21, a system module 32 and/or a part of a system module may comprise an AUTOSAR Adaptive software architecture. For example, in the first zone 20, a system module 30, 31, and/or a part of a system module may be configured to execute a first operating system (e.g., Windows) and, in the second zone 21, a system module 32 and/or a part of a system module may be configured to execute a second operating system (e.g., Linux).

In the above sections, the techniques of the present invention have often been described with reference to the respective methods. A second general aspect of the present disclosure, however, relates to a module for mitigating zone manipulations 10 of a computer system 100 (see also definitions above), which is designed to perform the computer-implemented methods according to the first general aspect.

A third general aspect of the present invention relates to a computer system 100 for a device, in particular for a vehicle, which comprises the module for mitigating zone manipulations 10 according to the second general aspect and a plurality of zones 20-23. Furthermore, the computer system of the third aspect comprises a plurality of system resources 60-63 assigned to corresponding zones of the plurality of zones 20-23.

A fourth general aspect of the present invention relates to a device comprising the computer system 100 according to the third general aspect.

A fifth general aspect of the present invention furthermore relates to a computer program containing commands that, when executed by a computer system, cause the computer system to perform a computer-implemented method according to the present disclosure.

The present invention furthermore relates to a computer-readable medium (e.g., a DVD or a solid-state memory) that contains a computer program of the fifth general aspect.

The present invention furthermore relates to a signal (e.g., an electromagnetic signal according to a wireless or wired communication protocol) that a computer program of the fifth general aspect encodes.

1-15. (canceled)

16. A computer-implemented method for mitigating a manipulation in a computer system for a device, the computer system including:
a plurality of zones, a plurality of system resources, and a module configured to mitigate zone manipulations that is configured to mitigate zone manipulations in each of the plurality of zones, wherein each zone is a logically and/or physically delimitable unit in the computer system, wherein a first zone of the plurality of zones is assigned a first number of system resources of the plurality of system resources, wherein a second zone of the plurality of zones is assigned a second number of system resources of the plurality of system resources, which second number differs from the first number of the plurality of system resources;
the method comprising the following steps:
identifying, by the module configured to mitigate zone manipulations, a possibility of a manipulation of the first zone of the plurality of zones and/or of a manipulation of the second zone of the plurality of zones, wherein a manipulated zone is a zone for which violations of rules relating to an assignment of system resources assigned to the zone have been identified; and
initiating, by the module configured to mitigate zone manipulations, a countermeasure to mitigate the manipulation of the first zone and/or the manipulation of the second zone.

17. The computer-implemented method according to claim 16, wherein the device is a vehicle.

18. The computer-implemented method according to claim 16, wherein:
the computer system is configured to provide a plurality of functions for the device,
the computer system further includes a plurality of system modules, wherein the plurality of system modules is configured to provide functions for the device,
each system module or a part of a system module of a first number of system modules of the plurality of system modules is assigned to the first zone of the plurality of zones, and
each system module or a part of a system module of a second number of system modules of the plurality of system modules is assigned to the second zone of the plurality of zones.

19. The computer-implemented method according to claim 16, further comprising:
identifying a manipulation of the first zone and/or a manipulation of the second zone, by a security module and/or by another corresponding module assigned to the manipulated zone; and
generating a signal indicating the manipulation of the first zone and/or of the second zone;
wherein identifying of the possibility of the manipulation of the first zone and/or of the second zone is carried out based on the signal indicating the manipulation of the manipulated zone.

20. The computer-implemented method according to claim 16, wherein the first zone of the plurality of zones is more trustworthy than the second zone of the plurality of zones, wherein a risk of a manipulation of a more trustworthy zone is lower than that of a less trustworthy zone.

21. The computer-implemented method according to claim 18, wherein the functions, provided by the system modules, for the operational safety of the device are of different criticality, wherein a first more critical function of the plurality of functions is provided by a system module of the first zone, and a less critical function of the plurality of functions is provided by a system module of the second zone.

22. The computer-implemented method according to claim 16, wherein each zone of the plurality of zones is assigned corresponding access rights to system resources, wherein the second zone is assigned fewer access rights to the second number of system resources than the first zone is assigned to the first number of system resources, wherein the second zone is assigned the access rights to the second number of system resources according to a principle of least privilege.

23. The computer-implemented method according to claim 16, wherein the initiating of the countermeasure to mitigate the manipulation includes one or more of:
changing access rights to system resources assigned to the manipulated and/or a non-manipulated zone;
blocking access to system resources assigned to the manipulated and/or the non-manipulated zone;
shutting off the manipulated and/or non-manipulated zone;
providing another zone and moving a functionality of the manipulated zone to the other zone;
resetting a functionality of the manipulated zone using information relevant to resetting the manipulated zone.

24. The computer-implemented method according to claim 23, wherein the providing of the other zone and moving the functionality of the manipulated zone to the other zone includes the following steps:
starting a new zone and/or using a non-manipulated zone that is in operation;
moving a functionality from one or more system modules assigned to the manipulated zone to one or more corresponding system modules assigned to the new zone and/or the non-manipulated zone.

25. The computer-implemented method according to claim 24, wherein the providing of the other zone and moving the functionality of the manipulated zone to the other zone includes one or more of:
assigning system resources of the manipulated zone to the new zone and/or the non-manipulated zone;
provisioning system resources for the new zone and/or the non-manipulated zone that replaced the manipulated zone; and
reducing a number of system resources of a zone that is less important than the manipulated zone, and assigning, to the new zone and/or the non-manipulated zone, released system resources that are released by reducing a number of system resources for the less important zone.

26. The computer-implemented method according to claim 23, wherein the resetting of the manipulated zone further includes the following steps:
requesting information relevant to resetting the manipulated zone;
generating or retrieving information relevant to resetting the manipulated zone.

27. The computer-implemented method according to claim 23, wherein the resetting of the manipulated zone further includes the following steps:
receiving information relevant to resetting the manipulated zone; and
restoring a functionality for the manipulated zone based on the relevant information.

28. A module configured to mitigate zone manipulations of a computer system, the computer system including:
a plurality of zones, and a plurality of system resources, wherein each zone is a logically and/or physically delimitable unit in the computer system, wherein a first zone of the plurality of zones is assigned a first number of system resources of the plurality of system resources, wherein a second zone of the plurality of zones is assigned a second number of system resources of the plurality of system resources, which second number differs from the first number of the plurality of system resources;
the module configured to:
identify, by the module configured to mitigate zone manipulations, a possibility of a manipulation of the first zone of the plurality of zones and/or of a manipulation of the second zone of the plurality of zones, wherein a manipulated zone is a zone for which violations of rules relating to an assignment of system resources assigned to the zone have been identified; and
initiate, by the module configured to mitigate zone manipulations, a countermeasure to mitigate the manipulation of the first zone and/or the manipulation of the second zone.

29. A computer system for a device, comprising:
a plurality of zones; and
a plurality of system resources assigned to corresponding zones of the plurality of zones, wherein each zone is a logically and/or physically delimitable unit in the computer system, wherein a first zone of the plurality of zones is assigned a first number of system resources of the plurality of system resources, wherein a second zone of the plurality of zones is assigned a second number of system resources of the plurality of system resources, which second number differs from the first number of the plurality of system resources; and
a module configured to mitigate zone manipulations of the computer system, the module configured to:
identify, by the module configured to mitigate zone manipulations, a possibility of a manipulation of the first zone of the plurality of zones and/or of a manipulation of the second zone of the plurality of zones, wherein a manipulated zone is a zone for which violations of rules relating to an assignment of system resources assigned to the zone have been identified, and
initiate, by the module configured to mitigate zone manipulations, a countermeasure to mitigate the manipulation of the first zone and/or the manipulation of the second zone

30. A non-transitory computer-readable medium on which is stored a computer program including commands for mitigating a manipulation in a computer system for a device, the computer system including:
a plurality of zones, a plurality of system resources, and a module configured to mitigate zone manipulations that is configured to mitigate zone manipulations in each of the plurality of zones, wherein each zone is a logically and/or physically delimitable unit in the computer system, wherein a first zone of the plurality of zones is assigned a first number of system resources of the plurality of system resources, wherein a second zone of the plurality of zones is assigned a second number of system resources of the plurality of system resources, which second number differs from the first number of the plurality of system resources;
the commands, executed by the computer system, causing the computer system to perform the following steps:
identifying, by the module configured to mitigate zone manipulations, a possibility of a manipulation of the first zone of the plurality of zones and/or of a manipulation of the second zone of the plurality of zones, wherein a manipulated zone is a zone for which violations of rules relating to an assignment of system resources assigned to the zone have been identified; and
initiating, by the module configured to mitigate zone manipulations, a countermeasure to mitigate the manipulation of the first zone and/or the manipulation of the second zone.
